(19) United States
(12) Patent Application Publication
(10) Pub. No.: US 2025/0373441 A1
(43) Pub. Date: Dec. 4, 2025

(54) USAGE RIGHT VERIFICATION SYSTEM, USAGE RIGHT VERIFICATION METHOD THEREOF, AND NON-TRANSITORY COMPUTER READABLE MEDIUM

(71) Applicant: NEC Corporation, Tokyo (JP)

(72) Inventors: Yoshitomo WARASHINA, Tokyo (JP); Toshiyuki ISSHIKI, Tokyo (JP); Kengo MORI, Tokyo (JP); Hiroto TAMIYA, Tokyo (JP); Saki OTSUKI, Tokyo (JP)

(73) Assignee: NEC Corporation, Tokyo (JP)

(21) Appl. No.: 19/207,905

(22) Filed: May 14, 2025

(30) Foreign Application Priority Data
May 31, 2024 (JP) 2024-088861

(51) Int. Cl. H04L 9/32; H04L 9/08

(52) U.S. Cl. CPC H04L 9/3247; H04L 9/0866; H04L 9/0894; H04L 9/321

(57) ABSTRACT

A usage right verification system includes a content use means for using a content; a usage right presentation proxy means for storing a key parameter in association with a biometric information; and a content management means for storing a public key for digital signature information based on a biometric information. The content use means transmits the biometric information and a usage right information of the content to the usage right presentation proxy means. The usage right presentation proxy means generates digital signature information of the user based on the biometric information and the key parameter corresponding to the biometric information, and transmits signed usage right information in which the digital signature information has been added to the usage right information to the content management means. The content management means verifies the digital signature information of the user by using the corresponding public key based on the signed usage right information.

### INCORPORATION BY REFERENCE

This application is based upon and claims the benefit of priority from Japanese patent application No. 2024-088861, filed on May 31, 2024, the disclosure of which is incorporated herein in its entirety by reference.

### TECHNICAL FIELD

The present disclosure relates to a usage right verification system, a usage right verification method thereof, and a program.

### BACKGROUND ART

In a digital content transaction system, for example, an apparatus of a user who wants to purchase and use content receives usage right information of the content. The user's apparatus can use the content based on the usage right information. In order to prevent unauthorized use of the usage right information, a system using a public key and a private key is known (see, for example, Patent Literature 1).
Patent Literature 1: Published Japanese Translation of PCT International Publication for Patent Application, No. 2008-529341

However, for example, when the secret key is passed to another person, there is concern that the other person may impersonate the user to illegally use the usage right information.

An example object of the present disclosure is to provide a usage right verification system, a usage right verification method thereof, and a program that can solve any of the problems described above.

### SUMMARY

A first example aspect of the present disclosure for achieving the above object is a usage right verification system including
a content use unit for acquiring biometric information of a user, storing usage right information of content, and using the content;
a usage right presentation proxy unit for storing a key parameter in association with the biometric information of the user; and
a content management unit for storing a public key for digital signature information of the user generated based on the biometric information of the user, in which
the content use unit transmits the acquired biometric information of the user and the usage right information of the content to the usage right presentation proxy unit,
the usage right presentation proxy unit generates digital signature information of the user based on the transmitted biometric information of the user and a key parameter corresponding to the biometric information, and transmits signed usage right information in which the digital signature information has been added to the usage right information to the content management unit, and
the content management unit verifies the digital signature information of the user by using the corresponding public key based on the signed usage right information.

A second example aspect of the present disclosure for achieving the above object is a usage right verification method for a usage right verification system including
a content use unit for acquiring biometric information of a user, storing usage right information of content, and using the content,
a usage right presentation proxy unit for storing a key parameter in association with the biometric information of the user, and
a content management unit for storing a public key for digital signature information of the user generated based on the biometric information of the user,
the usage right verification method including
a step of transmitting, by the content use unit, the acquired biometric information of the user and the usage right information of the content to the usage right presentation proxy unit;
a step of generating, by the usage right presentation proxy unit, digital signature information of the user based on the transmitted biometric information of the user and a key parameter corresponding to the biometric information, and transmitting signed usage right information in which the digital signature information has been added to the usage right information to the content management unit; and
a step of verifying, by the content management unit, the digital signature information of the user by using the corresponding public key based on the signed usage right information.

A third example aspect of the present disclosure for achieving the object is a program of a usage right verification system including
a content use unit for acquiring biometric information of a user, storing usage right information of content, and using the content,
a usage right presentation proxy unit for storing a key parameter in association with the biometric information of the user, and
a content management unit for storing a public key for digital signature information of the user generated based on the biometric information of the user,
the program causing a computer to perform processes of:
transmitting, by the content use unit, the acquired biometric information of the user and the usage right information of the content to the usage right presentation proxy unit;
generating, by the usage right presentation proxy unit, digital signature information of the user based on the transmitted biometric information of the user and a key parameter corresponding to the biometric information, and transmitting signed usage right information in which the digital signature information has been added to the usage right information to the content management unit; and
verifying, by the content management unit, the digital signature information of the user by using the corresponding public key based on the signed usage right information.

According to the present disclosure, a usage right verification system, a usage right verification method thereof, and a program that can solve any of the problems described above can be provided.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an example of a digital content transaction system according to the present disclosure;

FIG. 2 is a diagram illustrating an example of a configuration of a usage right verification system according to the present disclosure;

FIG. 3 is a diagram illustrating an example of a hardware configuration of a content management apparatus, a usage right presentation proxy apparatus, and a content use apparatus;

FIG. 4 is a diagram illustrating an example of a configuration of the usage right verification system according to the present disclosure;

FIG. 5 is a flowchart showing an example of a flow of a usage right verification method according to the present disclosure;

FIG. 6 is a diagram illustrating an example of a configuration of another usage right verification system according to the present disclosure;

FIG. 7 is a diagram illustrating an example of a configuration of a decision-making apparatus;

FIG. 8 is a diagram illustrating an example of a configuration of the usage right verification system according to the present disclosure; and

FIG. 9 is a flowchart showing an example of a flow of another usage right verification method according to the present disclosure.

### EXAMPLE EMBODIMENTS

### First Example Embodiment

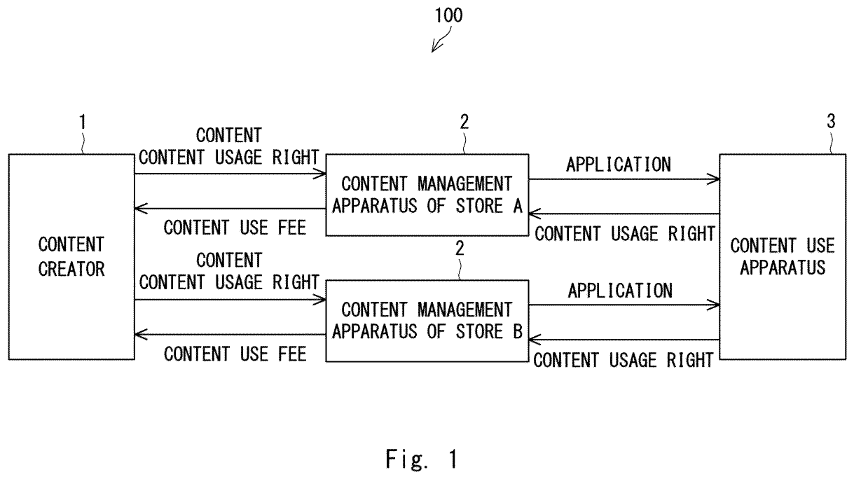

In a digital content transaction system 100, for example, a content creator and an apparatus 2 of a store (hereinafter, referred to as a “content management apparatus 2”) issue usage right information of content to an apparatus 3 of a user who wants to purchase and use the content (hereinafter, referred to as a “content use apparatus 3) as illustrated in FIG. 1. The content use apparatus 3 is configured to allow content to be used through an application or the like by presenting electronic usage right information of the content to each content management apparatus 2 that handles the same content.

The content use apparatus 3 includes not only an apparatus owned by an individual but also an apparatus shared with others. The content includes, for example, electronic books such as comics, novels, and magazines, videos, digital art, games, and music.

The usage right verification system according to the present example embodiment is a system for more reliably preventing unauthorized use of usage right information of content in the digital content transaction system 100 as described above.

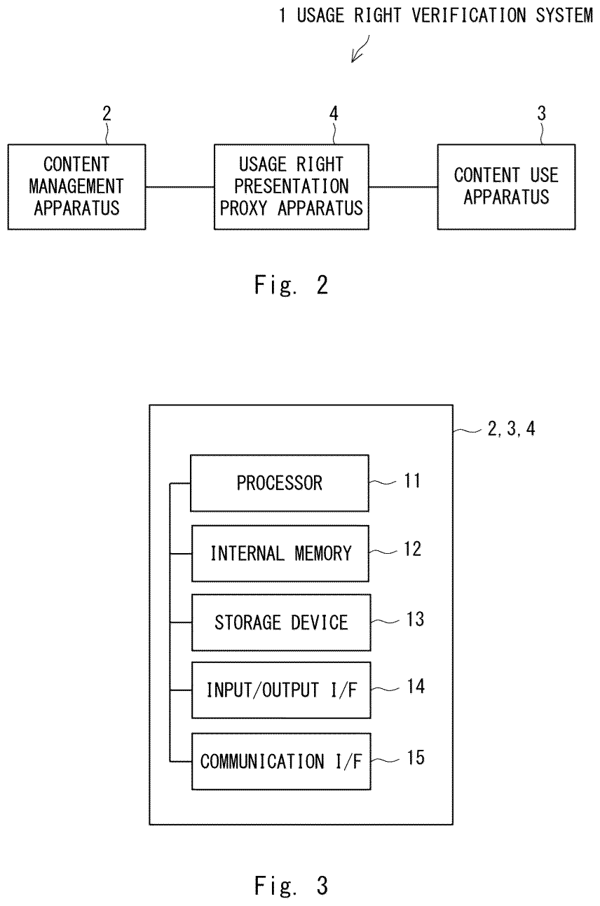

For this purpose, the usage right verification system according to the present example embodiment is characterized in that digital signature information of a user generated based on biometric information of the user is added to the usage right information of the content purchased by the user. In addition, the usage right verification system 1 according to the present example embodiment is characterized in that the generation of the digital signature information of the user and the presentation of the usage right information are executed by an apparatus 4 of a usage right presentation proxy (hereinafter, referred to as a “usage right presentation proxy apparatus 4) that is separate from the content use apparatus 3 as illustrated in FIG. 2.

The usage right verification system 1 includes the content management apparatus 2, the content use apparatus 3, and the usage right presentation proxy apparatus 4 as illustrated in FIG. 2.

The content use apparatus 3 is a specific example of a content use unit. The content use apparatus 3 transmits the biometric information of the user acquired from the user and the usage right information of the content to the usage right presentation proxy apparatus 4.

The usage right presentation proxy apparatus 4 is a specific example of a usage right presentation proxy unit. The usage right presentation proxy apparatus 4 generates digital signature information of the user based on the biometric information of the user transmitted from the content use apparatus 3 and key parameters corresponding to the biometric information. The key parameters corresponding to the biometric information are generated based on the biometric information of the user. The usage right presentation proxy apparatus 4 transmits signed usage right information in which the generated digital signature information has been added to the usage right information to the content management apparatus 2.

The content management apparatus 2 is a specific example of a content management unit. The content management apparatus 2 verifies the digital signature information of the user using the corresponding public key based on the signed usage right information. The corresponding public key is generated based on the biometric information of the user in advance. In a case where the verification of the digital signature information of the user is successful, the content management apparatus 2 transmits the content corresponding to the usage right information to the content use apparatus 3.

If the biometric information on which the key parameter is based at the time of generating the signature of the user as described above is the same as the biometric information of the user who is the signature generator, a correct digital signature is generated. The digital signature is verified by using a public key generated based on the same biometric information.

That is, it is more reliably determined whether the user is a legitimate owner of the usage right of the content based on whether the digital signature and the public key corresponding thereto are generated based on the same biometric information. This enables more reliable prevention of so-called impersonation in which the presenter of the usage right is switched from the user himself/herself to another individual. That is, unauthorized use of the usage right of the content can be prevented more reliably.

Note that the content management apparatus 2, the content use apparatus 3, and the usage right presentation proxy apparatus 4 may be wirelessly communicatively connected to each other via, for example, a wireless local area network (LAN), Wi-Fi (registered trademark), or the like.

Each of the content management apparatus 2, the content use apparatus 3, and the usage right presentation proxy apparatus 4 may have a hardware configuration of a normal computer including, for example, a processor 11 such as a central processing unit (CPU) or a graphics processing unit (GPU), an internal memory 12 such as a random access memory (RAM) or a read only memory (ROM), a storage device 13 such as a hard disk drive (HDD) or a solid state drive (SSD), an input/output I/F 14 for connecting a peripheral device such as a display, and a communication I/F 15 for communicating with a device outside the apparatus, as illustrated in FIG. 3.

Each of the content management apparatus 2 and the usage right presentation proxy apparatus 4 may be configured as a server apparatus. Each of the content management apparatus 2 and the usage right presentation proxy apparatus 4 may be configured to be integrated. In addition, the content use apparatus 3 may include a portable terminal such as a smartphone, a personal computer (PC), a tablet terminal, and the like.

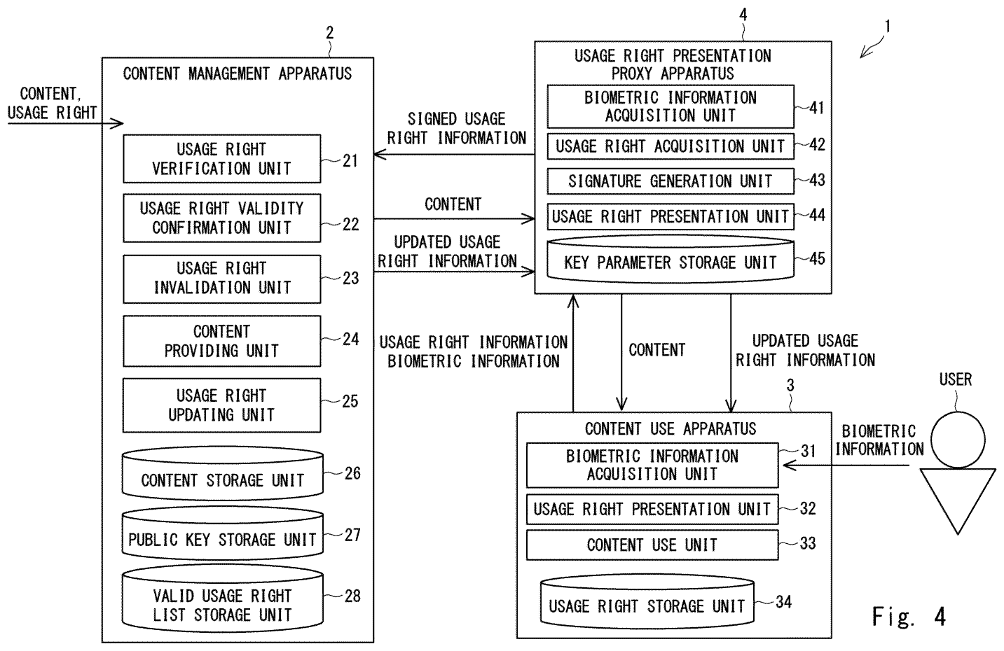

Next, a configuration and a function of the content management apparatus 2 will be described in detail. As illustrated in FIG. 4, the content management apparatus 2 includes a usage right verification unit 21, a usage right validity confirmation unit 22, a usage right invalidation unit 23, a content providing unit 24, a usage right updating unit 25, a content storage unit 26, a public key storage unit 27, and a valid usage right list storage unit 28.

The usage right verification unit 21 verifies digital signature information added to usage right information using a public key stored in the public key storage unit 27.

The usage right validity confirmation unit 22 checks the validity of the usage right information of the content based on list information of the valid usage right list storage unit 28.

The usage right invalidation unit 23 invalidates usage right information by deleting the usage right information from the list information of the valid usage right list storage unit 28 to be described below.

The content providing unit 24 presents the content stored in the content storage unit 26 by transmitting the content to the usage right presentation proxy apparatus 4.

The usage right updating unit 25 updates details of the usage right information in accordance with the use situation of the user. For example, the usage right updating unit 25 deletes the digital signature information of the user and the digital signature information of the content management apparatus 2 from the usage right information and updates the details of the usage right.

The content storage unit 26 stores content created by a content creator such as a writer in association with the usage right information thereof. The digital signature information of the content creator is added to the usage right information in advance. Furthermore, digital signature information of the content management apparatus 2 is also added to the usage right information in advance.

The public key storage unit 27 stores public keys for the digital signature information of the user, the digital signature information of the content management apparatus 2, and the digital signature information of the content creator. The public key storage unit 27 may store information (a link or the like) of the public key, instead of the public key. The public key storage unit 27 may acquire the public key from a cloud or the like based on the information of the public key.

The public key for the digital signature information of the user is generated in advance based on biometric information of the user. Either the content use apparatus 3 or the usage right presentation proxy apparatus 4 may generate the public key.

The valid usage right list storage unit 28 stores list information in which usage right information of valid content is listed.

Next, a configuration and a function of the usage right presentation proxy apparatus 4 will be described in detail. The usage right presentation proxy apparatus 4 includes a biometric information acquisition unit 41, a usage right acquisition unit 42, a signature generation unit 43, a usage right presentation unit 44, and a key parameter storage unit 45 as illustrated in FIG. 4.

The biometric information acquisition unit 41 acquires biometric information of the user from the content use apparatus 3. The usage right acquisition unit 42 acquires the usage right information from the content use apparatus 3.

The signature generation unit 43 generates digital signature information of the user based on the biometric information acquired from the content use apparatus 3 and key parameters stored in the key parameter storage unit and corresponding to the biometric information. The usage right presentation unit 44 presents the usage right information to the content management apparatus 2. The key parameter storage unit 45 stores key parameters. The key parameters are generated in advance based on the biometric information of the user. Either the content use apparatus 3 or the usage right presentation proxy apparatus 4 may generate the key parameters.

Next, a configuration and a function of the content use apparatus 3 will be described in detail. The content use apparatus 3 includes a biometric information acquisition unit 31, a usage right presentation unit 32, a content use unit 33, and a usage right storage unit 34 as illustrated in FIG. 4.

The biometric information acquisition unit 31 acquires the biometric information of the user based on, for example, an image of the user acquired by a camera, a voice of the user acquired by a microphone, or the like. The biometric information of the user includes, for example, information of the face, an iris, a fingerprint, a vein, a voiceprint, a palm print, an ear, and the like of the user.

The usage right presentation unit 32 presents the usage right information stored in the usage right storage unit 34 by transmitting the usage right information to the usage right presentation proxy apparatus 4.

The content use unit 33 uses the content transmitted from the usage right presentation proxy apparatus 4. In the present example embodiment, “using content” means that the content use unit 33 receives and simultaneously reproduces content transmitted from the usage right presentation proxy apparatus 4 based on, for example, the streaming method at any time without storing the content in the content use apparatus 3. As a result, unauthorized distribution of the content can be prevented more reliably.

The usage right storage unit 34 stores, for example, usage right information of the content that the user purchased from the content management apparatus 2 and updated usage right information to be described below.

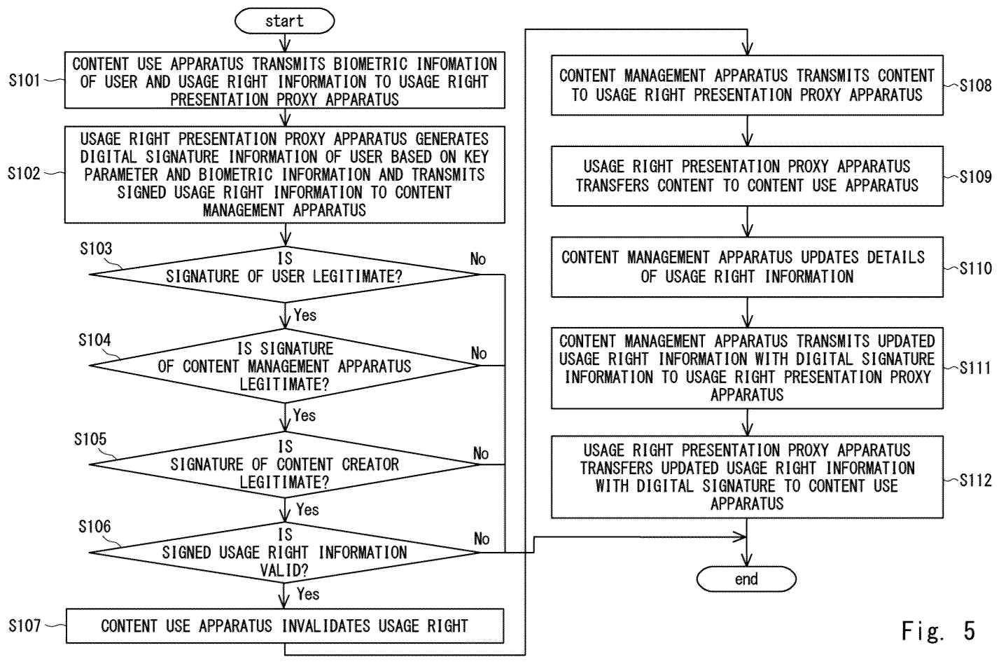

Next, an example of a usage right verification method for the usage right verification system 1 according to the present example embodiment described above will be described with reference to FIG. 5.

The usage right presentation unit 32 of the content use apparatus 3 transmits the biometric information of the user acquired by the biometric information acquisition unit 31 and the usage right information stored in the usage right storage unit 34 to the usage right presentation proxy apparatus 4 (step S101).

The signature generation unit 43 of the usage right presentation proxy apparatus 4 generates digital signature information of the user based on the biometric information transmitted from the content use apparatus 3 and key parameters stored in the key parameter storage unit 45 and corresponding to the biometric information. The usage right presentation unit 32 of the usage right presentation proxy apparatus 4 transmits signed usage right information in which the generated digital signature information of the user has been added to the usage right information to the content management apparatus 2 (step S102).

The usage right verification unit 21 of the content management apparatus 2 verifies the digital signature information of the user included in the signed usage right information from the usage right presentation proxy apparatus 4 by using the public key stored in the public key storage unit 27, thereby determining whether the signature of the user is legitimate (step S103).

If the usage right verification unit 21 of the content management apparatus 2 succeeds in verifying the digital signature information of the user and determines that the signature of the user is legitimate (YES in step S103), the following determination process (step S104) is performed. On the other hand, if the usage right verification unit 21 fails in verification of the digital signature information of the user and determines that the signature of the user is illegitimate (NO in step S103), this process ends.

The usage right verification unit 21 of the content management apparatus 2 verifies the digital signature information of the content management apparatus 2 included in the signed usage right information from the usage right presentation proxy apparatus 4 by using the public key stored in the public key storage unit 27, thereby determining whether the signature of the content management apparatus 2 is legitimate (step S104).

If the usage right verification unit 21 of the content management apparatus 2 succeeds in verifying the digital signature information of the content management apparatus 2 and determines that the signature of the content management apparatus 2 is legitimate (YES in step S104), the following determination process (step S105) is performed. On the other hand, if the usage right verification unit 21 fails in verification of the digital signature information of the content management apparatus 2 and determines that the signature of the content management apparatus 2 is illegitimate (NO in step S104), this process ends.

The usage right verification unit 21 of the content management apparatus 2 verifies the digital signature information of the content creator included in the signed usage right information from the usage right presentation proxy apparatus 4 by using the public key stored in the public key storage unit 27, thereby determining whether the signature of the content creator is legitimate (step S105).

If the usage right verification unit 21 of the content management apparatus 2 succeeds in verifying the digital signature information of the content creator and determines that the signature of the content creator is legitimate (YES in step S105), the following determination process (step S106) is performed. On the other hand, if the usage right verification unit 21 fails in verification of the digital signature information of the content creator and determines that the signature of the content creator is illegitimate (NO in step S105), this process ends.

The usage right validity confirmation unit 22 of the content management apparatus 2 determines whether the signed usage right information is valid based on the list information of the valid usage right list storage unit 28 (step S106).

If it is determined that the usage right of the signed usage right information is included in the list information of the valid usage right list storage unit 28 and the usage right of the content is valid (YES in step S106), the usage right validity confirmation unit 22 of the content management apparatus 2 performs the following processing (step S107). On the other hand, if it is determined that the usage right of the signed usage right information is not included in the list information of the valid usage right list storage unit 28 and the usage right of the content is not valid (NO in step S106), the usage right validity confirmation unit 22 ends the present processing.

The usage right invalidation unit 23 of the content management apparatus 2 invalidates the usage right by deleting the usage right of the signed usage right information from the list information of the valid usage right list storage unit 28 (step S107).

The content providing unit 24 of the content management apparatus 2 transmits the content stored in the content storage unit 26 and associated with the signed usage right information to the usage right presentation proxy apparatus 4 (step S108).

The usage right presentation proxy apparatus 4 transfers the content transmitted from the content management apparatus 2 to the content use apparatus 3 (step S109). As a result, the user can use the content in the content use apparatus 3.

The content providing unit 24 of the content management apparatus 2 may transmit the content associated with the signed usage right information to the content use apparatus 3 directly without going through the usage right presentation proxy apparatus 4.

The usage right updating unit 25 of the content management apparatus 2 deletes the digital signature information of the user and the digital signature information of the content management apparatus 2 from the signed usage right information, thereby updating the details of the usage right information according to the use situation of the user (step S110).

The content management apparatus 2 adds the digital signature information to the above-described usage right information updated (hereinafter, referred to as “updated usage right information”) and transmits the updated usage right information with the digital signature information to the usage right presentation proxy apparatus 4 (step S111).

The usage right presentation proxy apparatus 4 transfers the updated usage right information with the digital signature information transmitted from the content management apparatus 2 to the content use apparatus 3 (step S112). The usage right storage unit 34 of the content use apparatus 3 stores the updated usage right information with the digital signature information transferred from the usage right presentation proxy apparatus 4.

The content management apparatus 2 may transmit the updated usage right information with the digital signature information to the content use apparatus 3 directly without going through the usage right presentation proxy apparatus 4.

In addition, at least one of (step S104) and (step S105) in the determination process described above may be omitted. In addition, the order of (step S104) to (step S105) of the determination process may be arbitrary.

As described above, according to the usage right verification method of the usage right verification system 1 according to the present example embodiment, the identity associated with the usage right of the content is authenticated using the biometric information of the user, instead of a secret key. Therefore, impersonation resulting from the leakage of a secret key can be prevented more reliably. In addition, since only the user himself/herself can generate correct digital signature information, unauthorized transfers of usage rights (resale or the like) can be prevented more reliably. Furthermore, in the process of adding and presenting the signature of the usage right, there is no chance to switch the transmission source from the original user to another person. Therefore, impersonation resulting from the transfer or theft of signed usage rights can be prevented more reliably.

### Second Example Embodiment

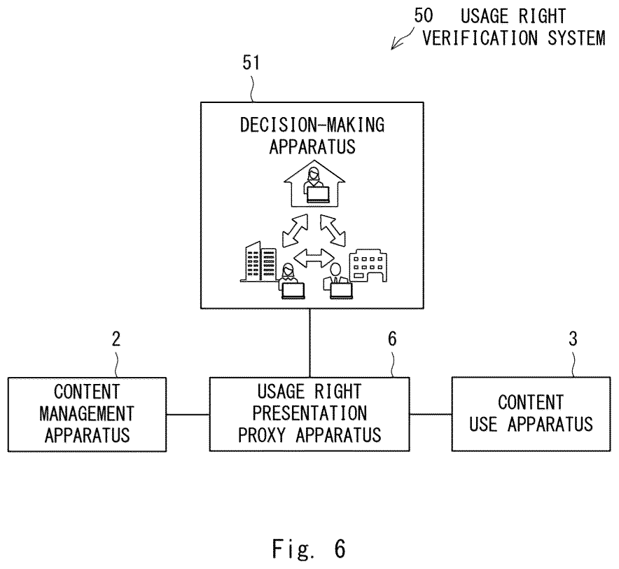

A usage right verification system 50 according to the present example embodiment further includes a decision-making apparatus 51 that performs decision-making based on majority decision by a plurality of decision-making units as illustrated in FIG. 6. The decision-making apparatus 51 is a specific example of a decision-making unit. The decision-making apparatus 51 is configured as, for example, a decentralized autonomous organization (DAO).

The decision-making apparatus 51 determines whether a usage right presentation proxy apparatus 6 may transmit (present) signed usage right information to the content management apparatus 2 based on majority decision of the plurality of decision-making units. As a result, it is possible to more reliably prevent a usage right presentation proxy or the like from leaking signed usage right information to an entity other than the user.

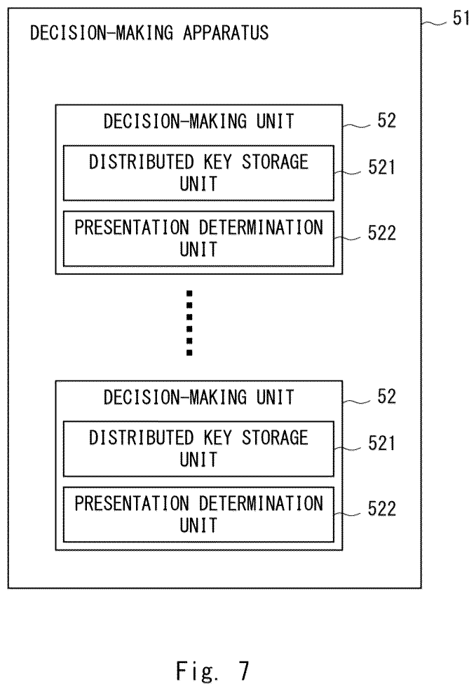

For example, the decision-making apparatus 51 includes n (n≥3) decision-making units 52 as illustrated in FIG. 7. Each decision-making unit 52 includes a distributed key storage unit 521 and a presentation determination unit 522.

The distributed key storage unit 521 stores a distributed key. For example, n distributed keys are generated from one decryption key and stored one by one in the distributed key storage units 521 of the n decision-making units 52. The presentation determination unit 522 determines whether to transmit the signed usage right information.

When the presentation of the signed usage right information is determined to be “possible”, the presentation determination unit 522 of each decision-making unit 52 transmits a distributed key of the distributed key storage unit 521 to the usage right presentation proxy apparatus 6 in response to a request from the usage right presentation proxy apparatus 6. The usage right presentation proxy apparatus 6 decrypts the encrypted key parameter based on the distributed key transmitted from each decision-making unit 52 as will be described below.

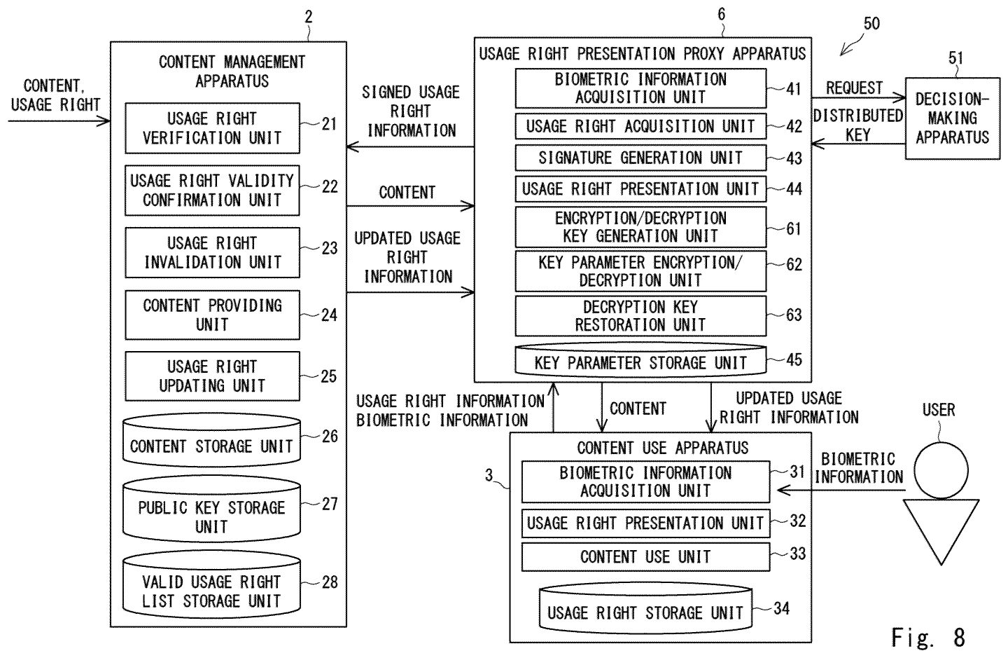

The usage right presentation proxy apparatus 6 according to the present example embodiment further includes, in addition to the above configuration, an encryption/decryption key generation unit 61, a key parameter encryption/decryption unit 62, and a decryption key restoration unit 63 as illustrated in FIG. 8.

The encryption/decryption key generation unit 61 generates an encryption key that encrypts a key parameter necessary for generating digital signature information of the user. In addition, the encryption/decryption key generation unit 61 generates a decryption key for decrypting the encrypted key parameter, and generates n distributed keys from the generated decryption key. The encryption/decryption key generation unit 61 transmits the generated n distributed keys to the n decision-making units 52.

The key parameter encryption/decryption unit 62 encrypts the key parameter using the encryption key and decrypts the encrypted key parameter using the decryption key.

The decryption key restoration unit 63 restores the decryption key based on a plurality of distributed keys transmitted from the decision-making units 52. For example, when distributed keys indicating “possible” are obtained from m (m≤n) decision-making units 52 among the n decision-making units 52, the decryption key restoration unit 63 restores the decryption key using the distributed keys. The key parameter encryption/decryption unit 62 decrypts the encrypted key parameter of the key parameter storage unit 45 using the decryption key restored by the decryption key restoration unit 63.

The signature generation unit 43 can generate digital signature information of the user based on the biometric information transmitted from the content use apparatus 3 and the decrypted key parameter. Then, the usage right presentation unit 32 can transmit the signed usage right information in which the generated digital signature information of the user has been added to the usage right information to the content management apparatus 2.

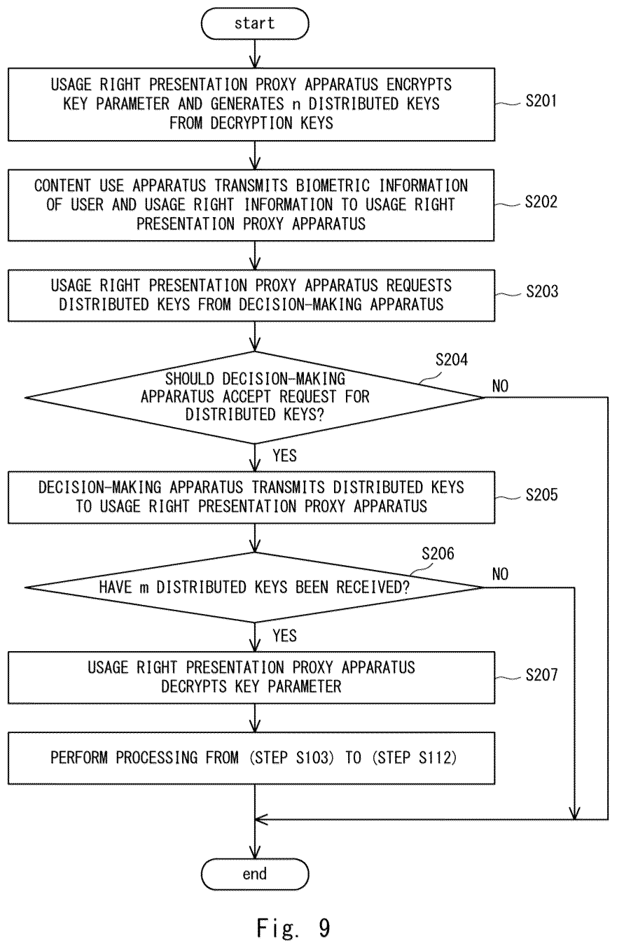

Next, an example of a usage right verification method by the usage right verification system according to the present example embodiment described above will be described with reference to FIG. 9.

The key parameter encryption/decryption unit 62 of the usage right presentation proxy apparatus 6 encrypts the key parameter of the key parameter storage unit using the encryption key. The key parameter encryption/decryption unit 62 generates n distributed keys from the decryption key. The key parameter encryption/decryption unit 62 transmits the generated n distributed keys to each of the n decision-making units 52 of the decision-making apparatus 51, and stores the generated n distributed keys one by one in each distributed key storage unit 521 (step S201).

The usage right presentation unit 32 of the content use apparatus 3 transmits the biometric information of the user acquired by the biometric information acquisition unit 31 and the usage right information stored in the usage right storage unit 34 to the usage right presentation proxy apparatus 6 (step S202).

The usage right presentation proxy apparatus 6 requests the distributed keys from the n decision-making units 52 of the decision-making apparatus 51 (step S203).

The presentation determination unit 522 of each decision-making unit 52 determines that the presentation of the signed usage right information is “possible”, and determines whether to accept the request for the distributed keys (step S204).

If it is determined to accept the request for the distributed keys (YES in step S204), each presentation determination unit 522 transmits the distributed keys of the distributed key storage unit 521 to the usage right presentation proxy apparatus 6 (step S205).

The decryption key restoration unit of the usage right presentation proxy apparatus 6 determines, for example, whether m (m≤n) distributed keys have been received (step S206).

If it is determined that m distributed keys have been received (YES in step S206), the decryption key restoration unit 63 restores the decryption key based on the received distributed keys. The key parameter encryption/decryption unit 62 decrypts the encrypted key parameter of the key parameter storage unit 45 using the decryption key restored by the decryption key restoration unit 63 (step S207).

The signature generation unit 43 of the usage right presentation proxy apparatus 6 generates digital signature information of the user based on the biometric information transmitted from the content use apparatus 3 and the decrypted key parameter. The usage right presentation unit 32 of the usage right presentation proxy apparatus 6 transmits signed usage right information in which the generated digital signature information of the user has been added to the usage right information to the content management apparatus 2 (step S208).

In the subsequent processing, processing similar to the processing of (step S103) to (step S112) illustrated in FIG. 5 is executed. Therefore, the description in FIG. 5 is cited, and the detailed description is omitted here.

The configuration of the decision-making apparatus 51 is an example, and is not limited thereto. The decision-making units 52 of the decision-making apparatus 51 may be physically separated apparatuses. The decision-making apparatus 51 may have any configuration as long as it can determine whether to transmit the signed usage right information based on majority decision by a plurality of decision-making units 52.

The decision-making apparatus 51 may also be provided in the content management apparatus 2. In this case, the decision-making apparatus 51 determines whether reception of the signed usage right information from the usage right presentation proxy apparatus 6 is possible based on majority decision of the plurality of decision-making units 52. As a result, it is possible to more reliably prevent a usage right presentation proxy or the like from leaking the signed usage right information to an entity other than the user.

According to the present disclosure, for example, the processing shown in FIG. 5 or FIG. 9 can also be implemented by causing a processor to execute a computer program.

The program can be stored using various types of non-transitory computer readable media to be supplied to a computer. The non-transitory computer readable media include various types of tangible storage media. Examples of the non-transitory computer readable medium include magnetic recording media (for example, a flexible disk, a magnetic tape, and a hard disk drive), a magneto-optical recording medium (for example, a magneto-optical disk), a CD-read only memory (ROM), a CD-R, a CD-R/W, and semiconductor memories (for example, a mask ROM, a programmable ROM (PROM), an erasable PROM (EPROM), a flash ROM, and a random access memory (RAM)).

The program may be supplied to the computer by various types of transitory computer readable media. Examples of transitory computer readable media include electrical signals, optical signals, and electromagnetic waves. The transitory computer readable media can supply the programs to the computer via a wired communication path such as an electric wire and an optical fiber or a wireless communication path.

Each of the units constituting the usage right verification systems 1 and 50 according to the above-described example embodiments can be realized by a program, and in addition, some or all of the units can be realized by dedicated hardware such as an application specific integrated circuit (ASIC) or a field-programmable gate array (FPGA).

Although the present disclosure has been described hitherto with reference to the example embodiments, the present disclosure is not limited to the example embodiments described above. Various modifications that can be understood by those skilled in the art can be made to the configurations and details of the present disclosure within the scope of the present disclosure. Each example embodiment can be appropriately combined with another example embodiment.

Each of the drawings or figures is merely an example to illustrate one or more example embodiments. Each drawing is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the drawings for describing illustrative example embodiments are not necessarily mandatory, and some features or steps may be omitted. The order of the steps described in any of the figures may be changed as appropriate.

Some or all of the above-described example embodiments may be described as in the following Supplementary Notes, but are not limited to the following Supplementary Notes.

### (Supplementary Note 1)

A usage right verification system including:
a content use means for acquiring biometric information of a user, storing usage right information of content, and using the content;
a usage right presentation proxy means for storing a key parameter in association with the biometric information of the user; and
a content management means for storing a public key for digital signature information of the user generated based on the biometric information of the user, in which
the content use means transmits the acquired biometric information of the user and the usage right information of the content to the usage right presentation proxy means,
the usage right presentation proxy means generates digital signature information of the user based on the transmitted biometric information of the user and a key parameter corresponding to the biometric information, and transmits signed usage right information in which the digital signature information has been added to the usage right information to the content management means, and
the content management means verifies the digital signature information of the user by using the corresponding public key based on the signed usage right information.

### (Supplementary Note 2)

The usage right verification system described in supplementary note 1, in which the content management means transmits the content corresponding to the usage right information to the content use means when the content management means succeeds in verifying the digital signature information of the user.

### (Supplementary Note 3)

The usage right verification system described in supplementary note 1, further including a decision-making means for deciding whether the usage right presentation proxy means may transmit the signed usage right information to the content management means based on majority decision of a plurality of decision-making units.

### (Supplementary Note 4)

The usage right verification system described in supplementary note 3, in which
the decision-making unit includes a distributed key storage unit that stores a distributed key, and a presentation determination unit that determines whether transmission of signed usage right information is possible,
the presentation determination unit of each of the decision-making units transmits the distributed key of the distributed key storage unit to the usage right presentation proxy means in response to a request from the usage right presentation proxy means based on a result of the determination of the possibility, and
the usage right presentation proxy means restores a decryption key by using the transmitted distributed key, decrypts an encrypted key parameter by using the restored decryption key, and generates digital signature information of the user based on the transmitted biometric information of the user and the decrypted key parameter.

### (Supplementary Note 5)

The usage right verification system described in supplementary note 1, in which
the content management means stores a public key for digital signature information of the user, a public key for digital signature information of the content management means, and a public key for digital signature information of a content creator, and
the content management means performs first verification on the digital signature information of the user by using the corresponding public key, performs second verification on the digital signature information of the content management means by using the corresponding public key, and performs third verification on the digital signature information of the content creator by using the corresponding public key based on the signed usage right information, and transmits content corresponding to the usage right information to the content use means if the first verification, the second verification, and the third verification are successful.

### (Supplementary Note 6)

The usage right verification system described in supplementary note 1, in which the content management means stores list information including usage right information of valid content, and determines whether the usage right of the signed usage right information is valid based on the list information.

### (Supplementary Note 7)

The usage right verification system described in supplementary note 1, in which the content use means receives and simultaneously reproduces content transmitted from the usage right presentation proxy means without storing the content in the content use means.

### (Supplementary Note 8)

The usage right verification system described in supplementary note 1, in which the content management means deletes digital signature information of the user and digital signature information of the content management means from the signed usage right information, updates details of the signed usage right information, and transmits updated usage right information in which the digital signature information has been added to the updated usage right information to the content use means.

### (Supplementary Note 9)

A usage right verification method for a usage right verification system including:
a content use means for acquiring biometric information of a user, storing usage right information of content, and using the content;
a usage right presentation proxy means for storing a key parameter in association with the biometric information of the user; and
a content management means for storing a public key for digital signature information of the user generated based on the biometric information of the user,
the usage right verification method including:
a step of transmitting, by the content use means, the acquired biometric information of the user and the usage right information of the content to the usage right presentation proxy means;
a step of generating, by the usage right presentation proxy means, digital signature information of the user based on the transmitted biometric information of the user and a key parameter corresponding to the biometric information, and transmitting signed usage right information in which the digital signature information has been added to the usage right information to the content management means; and
a step of verifying, by the content management means, the digital signature information of the user by using the corresponding public key based on the signed usage right information.

### (Supplementary Note 10)

A program of a usage right verification system including:
a content use means for acquiring biometric information of a user, storing usage right information of content, and using the content;
a usage right presentation proxy means for storing a key parameter in association with the biometric information of the user; and
a content management means for storing a public key for digital signature information of the user generated based on the biometric information of the user,
the program for causing a computer to perform processes of:
transmitting, by the content use means, the acquired biometric information of the user and the usage right information of the content to the usage right presentation proxy means;
generating, by the usage right presentation proxy means, digital signature information of the user based on the transmitted biometric information of the user and a key parameter corresponding to the biometric information, and transmitting signed usage right information in which the digital signature information has been added to the usage right information to the content management means; and
verifying, by the content management means, the digital signature information of the user by using the corresponding public key based on the signed usage right information.

Some or all of the elements (for example, configurations and functions) described in Supplementary notes 2 to 8 citing Supplementary note 1 {e.g. apparatus} can also be dependent on Supplementary note 9 {e.g. method} and Supplementary note 10 {e.g. program} by the same dependency relationship as Supplementary notes 2 to 8. Some or all of the elements described in any supplementary note may be applied to various types of hardware, software, recording means for recording software, systems, and methods.

The first and second embodiments can be combined as desirable by one of ordinary skill in the art.)

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A usage right verification system comprising:
a content use apparatus that acquires biometric information of a user, storing usage right information of content, and using the content;
a usage right presentation proxy apparatus that stores a key parameter in association with the biometric information of the user; and
a content management apparatus that stores a public key for digital signature information of the user generated based on the biometric information of the user, wherein
the content use apparatus transmits the acquired biometric information of the user and the usage right information of the content to the usage right presentation proxy apparatus,
the usage right presentation proxy apparatus generates digital signature information of the user based on the transmitted biometric information of the user and a key parameter corresponding to the biometric information, and transmits signed usage right information in which the digital signature information has been added to the usage right information to the content management apparatus, and
the content management apparatus verifies the digital signature information of the user by using the corresponding public key based on the signed usage right information.

2. The usage right verification system according to claim 1, wherein the content management apparatus transmits the content corresponding to the usage right information to the content use apparatus when the content management apparatus succeeds in verifying the digital signature information of the user.

3. The usage right verification system according to claim 1, further comprising a decision-making apparatus that decides whether the usage right presentation proxy apparatus may transmit the signed usage right information to the content management apparatus based on majority decision of a plurality of decision-making units.

4. The usage right verification system according to claim 3, wherein
the decision-making unit includes a distributed key storage unit configured to store a distributed key and a presentation determination unit configured to determine whether transmission of signed usage right information is possible,
the presentation determination unit of each of the decision-making units transmits the distributed key of the distributed key storage unit to the usage right presentation proxy apparatus in response to a request from the usage right presentation proxy apparatus based on a result of the determination of the possibility, and
the usage right presentation proxy apparatus restores a decryption key by using the transmitted distributed key, decrypts an encrypted key parameter by using the restored decryption key, and generates digital signature information of the user based on the transmitted biometric information of the user and the decrypted key parameter.

5. The usage right verification system according to claim 1, wherein
the content management apparatus stores a public key for digital signature information of the user, a public key for digital signature information of the content management apparatus, and a public key for digital signature information of a content creator, and
the content management apparatus performs first verification on the digital signature information of the user by using the corresponding public key, performs second verification on the digital signature information of the content management apparatus by using the corresponding public key, and performs third verification on the digital signature information of the content creator by using the corresponding public key based on the signed usage right information, and transmits content corresponding to the usage right information to the content use apparatus if the first verification, the second verification, and the third verification are successful.

6. The usage right verification system according to claim 1, wherein the content management apparatus stores list information including usage right information of valid content, and determines whether a usage right of the signed usage right information is valid based on the list information.

7. The usage right verification system according to claim 1, wherein the content use apparatus receives and simultaneously reproduces content transmitted from the usage right presentation proxy apparatus without storing the content in the content use apparatus.

8. The usage right verification system according to claim 1, wherein the content management apparatus deletes digital signature information of the user and digital signature information of the content management apparatus from the signed usage right information, updates details of the signed usage right information, and transmits updated usage right information in which the digital signature information has been added to the updated usage right information to the content use apparatus.

9. A usage right verification method for a usage right verification system including:
a content use apparatus that acquires biometric information of a user, storing usage right information of content, and using the content;
a usage right presentation proxy apparatus that stores a key parameter in association with the biometric information of the user; and
a content management apparatus that stores a public key for digital signature information of the user generated based on the biometric information of the user,
the usage right verification method comprising:
transmitting, by the content use apparatus, the acquired biometric information of the user and the usage right information of the content to the usage right presentation proxy apparatus;
generating, by the usage right presentation proxy apparatus, digital signature information of the user based on the transmitted biometric information of the user and a key parameter corresponding to the biometric information, and transmitting signed usage right information in which the digital signature information has been added to the usage right information to the content management apparatus; and
verifying, by the content management apparatus, the digital signature information of the user by using the corresponding public key based on the signed usage right information.

10. A non-transitory computer readable medium storing a program of a usage right verification system including:
a content use apparatus that acquires biometric information of a user, storing usage right information of content, and using the content;
a usage right presentation proxy apparatus that stores a key parameter in association with the biometric information of the user; and
a content management apparatus that stores a public key for digital signature information of the user generated based on the biometric information of the user,
the program causing a computer to perform processes of:
transmitting, by the content use apparatus, the acquired biometric information of the user and the usage right information of the content to the usage right presentation proxy apparatus;
generating, by the usage right presentation proxy apparatus, digital signature information of the user based on the transmitted biometric information of the user and a key parameter corresponding to the biometric information, and transmitting signed usage right information in which the digital signature information has been added to the usage right information to the content management apparatus; and
verifying, by the content management apparatus, the digital signature information of the user by using the corresponding public key based on the signed usage right information.
